(19) United States
(12) Patent Application Publication
(10) Pub. No.: US 2007/0178948 A1
(43) Pub. Date: Aug. 2, 2007

(54) Mobile phone assembly

(76) Inventors: Esa-Sakari Maatta, Viiala (FI); Timo Herranen, Viiala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/583,057

(22) PCT Filed: Dec. 19, 2003
(86) PCT No.: PCT/FI03/00972

§ 371 Date: Jun. 14, 2006

(51) Int. Cl. H04M 1/00

(52) U.S. Cl. 455/575.3

(57) ABSTRACT

A mobile phone (50) having a one base part (10) integrated of a hard body part (11), a phone window (4) and a soft middle part (12), which is connecting the mentioned parts (4, 11) and that the phone window (4) is foldable against the hard body part (11) along a hinge line (13) created in the soft middle part (12).

### TECHNICAL FIELD

This invention relates to a mobile phone assembly and more particularly to an integration of the parts in mobile phones. The invention relates also to a method of manufacturing such a mobile phone.

### BACKGROUND OF THE INVENTION

Nowadays a mobile phone includes many separate parts which are assembled together in many various stages. These parts are usually made of hard plastic using injection molding or pressing. A mobile phones base contains usually two base parts, the upper and the lower base part, which are connected together with fastening means. Between those two base parts or on the top of upper base part are assembled for example an earpiece, a display light guide, a keypad, a keypad light guide, a buzzer, a phone window, a display, a display connector and a key graphics printing. Additionally there may be many various parts to prevent the undesired movement or the moistening of those parts such as various holders and gaskets.

Manufacturing of these various parts with injection molding requires many separate molds. After making all necessary parts the fabrication of the mobile phone includes assembling all parts together. These stages require an expensive machinery or manual labor. The number of separate molds and required machinery or manual labor are increasing the costs of the mobile phone. There is a continuous need in the market to cut down the costs of manufacturing the mobile phone.

### DISCLOSURE OF THE INVENTION

The primary object of the present invention is to cut down the number of separate parts of the mobile phone and by this way reduce time and stages in the assembly.

Another object of the invention is to reduce the costs of the complete mobile phone. All these mentioned advantages are achieved by integrating the various parts.

The characteristic features of the invention that are enabling the foresaid advantages are described in the claims.

In the following the invention is described more accurately with reference to the enclosed drawings.

### BRIEF DESCRIPTION OF THE DRAWINGS

FIG. 1 is an exploded view of a prior art mobile phone,

FIG. 2 is an exploded view of a mobile phone according to this invention when the base part is open,

FIG. 3 is a view of the base part after the first injection phase,

FIG. 4 is a view of the base part after the second injection phase, and

FIGS. 5a-5c are illustrating the closing of the mobile phones base part.

### DESCRIPTION OF PRIOR ART MOBILE PHONE

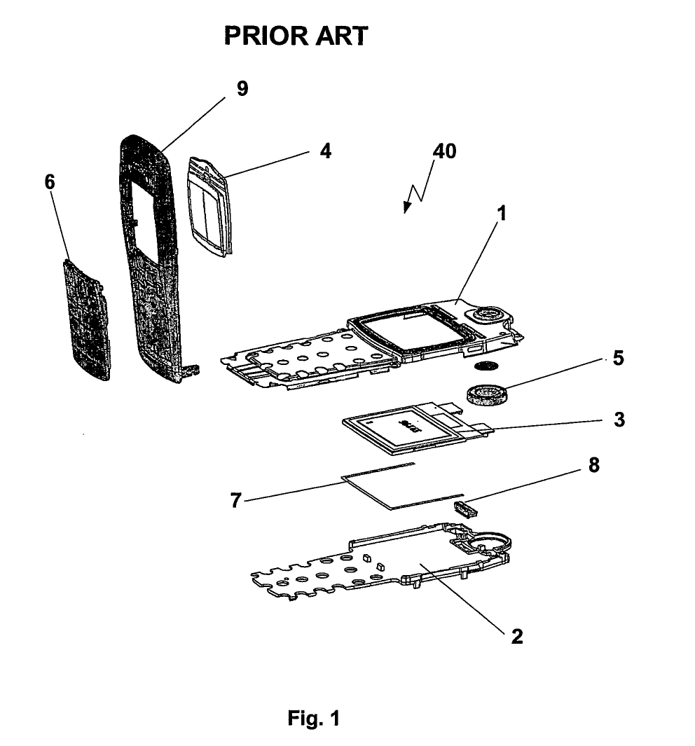

FIG. 1 illustrates an exploded view of a prior art mobile phone 40. The mobile phone 40 has an upper base part 1 and a lower base part 2, which are connected together typically with a releasable connection accomplished by connecting means. These connecting means are typically various projecting parts and counterparts and the connection is a snap-on type connection. Between these base parts 1 and 2, or to these parts, are assembled various supplementary parts which are necessary for operating the mobile phone 40. These parts are for example a display 3, a phone window 4, an earpiece 5, a keypad 6, a display holding adhesive 7, and a display connector 8. Further the base part 2 comprises a display light guide, a display connector holder, a keypad light guide. The base part 1 comprises a display gasket, an earpiece holder, an earpiece gasket. Further the mobile phone comprises a buzzer, a buzzer gasket and a buzzer holder, which parts are not shown in the FIG. 1. The base parts 1 and 2 are essentially smaller than the upper cover 9 which covers the whole mobile phone's 40 front from the top to the bottom.

### BEST MODE FOR CARRYING OUT THE INVENTION

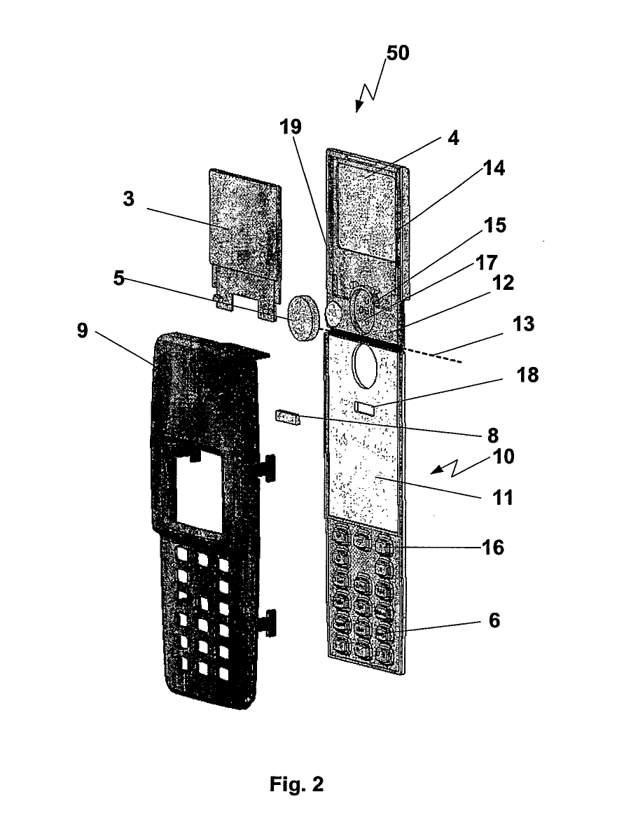

FIG. 2 shows an exploded view of the mobile phone 50 according to the present invention. The mobile phone 50 has one base part 10, which comprises a hard body part 11, a phone window 4 and a soft middle part 12. The soft middle part 12 has a hinge line 13 to fold up the phone window 4 against the hard body part 11 and to close the display 3 between the hard body part and the phone window. The closing connection is advantageously made as a snap-on type connection with projecting parts and counterparts (not shown in the FIG. 2). At the hinge line 13 the soft middle part 12 has advantageously a thinned material thickness so that the phone window 4 can be folded without breaking the material. The material of the middle part 12 at the area of hinge line 13 and in its surroundings is some soft elastomer.

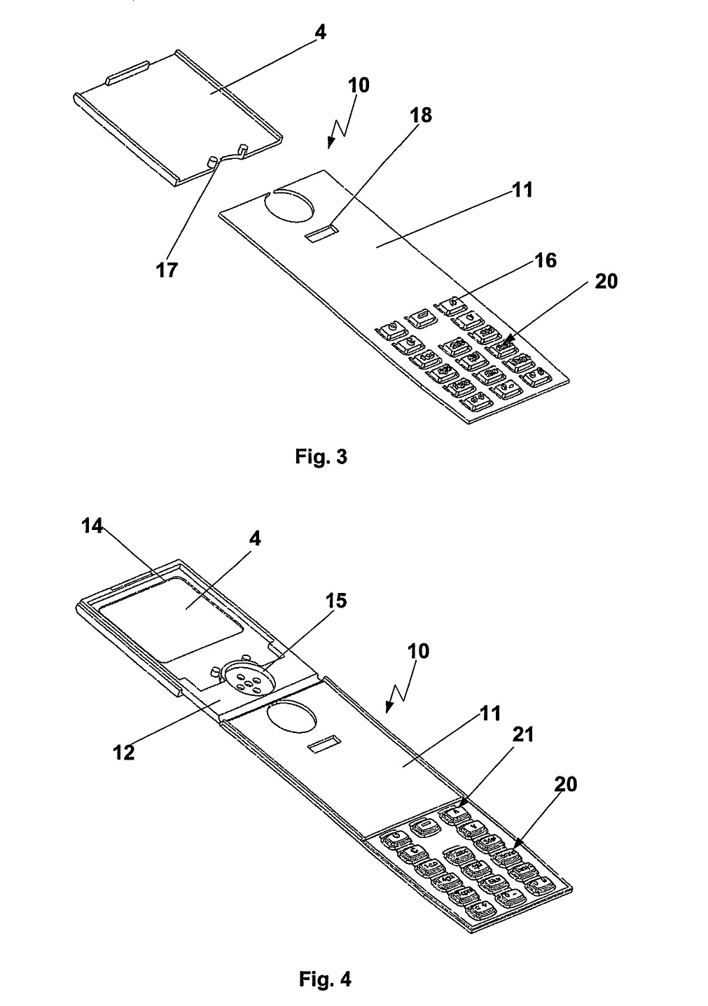

After the phone window 4 is folded against the hard body part 11 (shown later in FIGS. 3a-3c) the upper cover 9 and a cover containing the phone's engine including a battery (not shown in the figs.) are connected to the base part 10. When the phone window 4 is folded against the hard body part 11, the display 3, the earpiece 5 and the display connector 8 are included inside the hard body part and the phone window or phone window's surroundings (the soft middle part 12).

To the base part 10 are advantageously integrated one or more of the following parts; a display gasket 14, an earpiece gasket 15, a keypad 6, a keypad graphics printing 16, an earpiece holder 17, a display connector holder 18, a display holder 19, which parts are shown in the FIG. 2, a display light guide, a keypad light guide. A buzzer gasket and a buzzer holder, which parts are not visible or shown in the FIG. 2, can be integrated to the base part 10. The integration is made at manufacturing stage when the base part 11 is made with injection molding in two phases (see FIGS. 3 and 4).

In FIG. 3 is presented the result of the first phase of the injection molding when the two parts (the phone window 4 and the hard body part 11 of the base part 10) are injected. The two parts 4 and 11 are made advantageously of a hard clear plastic. The hard parts 4 and 11 of the base part 10 have advantageously integrated holders for the various parts that are necessary for operating the mobile phone such as the display connector holder 8 and part of the earpiece holder 17. The injection molded hard body part 10 can also consist the graphics 16 for the keypad 6 as an embossed surface 20 and thus there is no need to assemble separate printed graphics to the keypad. All these above mentioned parts can be optionally included to the first molding phase and be integrated to the base part 10, but they all are not necessarily included. Many different variations of these parts can be made.

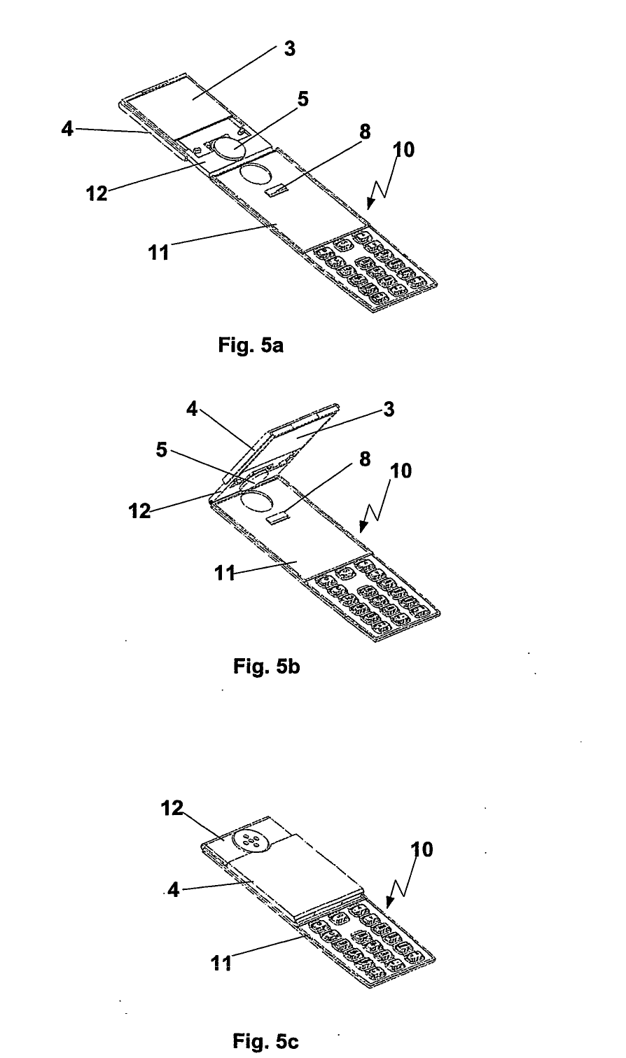

At the second phase of the injection molding a soft opaque elastomere is injected to the mold to produce a connecting soft middle part 12 between the phone window 4 and the hard body part 11 and integrating those two parts together into one base part 10 as shown in FIG. 4. The soft elastomere forms the soft middle part 12 of the base part 10 and has the hinge line 13 where the phone window 4 is folded up against the hard body part 11. The elastomere can also be used to form the necessary gaskets for various parts such as the display gasket 14, the earpiece gasket 15 and the buzzer gasket (not shown in FIG. 5) and a contacting surface 21 to the keypad 6. The contacting surface 21 of the keypad 6 doesn't cover the embossed surface 20 of the keypad so that the illumination is visible to the user through the embossed parts of the keypad.

The transparent base part 11 works as display light guide and keypad light guide.

When the phone window 4 is folded up against the hard body part 11 as presented in FIGS. 5a-5c there is no need for any auxiliary holders for the other assembled parts. The folded part (the phone window 4 and part of the soft middle part 12) of the base part 10 are closing the earpiece 5, the display 3, the display connector 8 and the optional buzzer (not in figs.) inside so that they keep their desired position automatically.

While there have been shown and described what are at present considered the preferred embodiments of the invention, it will be obvious to the person skilled in the art that various changes and modifications can be made therein without departing from the scope of the invention as defined by the appended claims.

1. A base part for mobile phone, wherein a base part is integrated of a hard body part, a phone window and a soft middle part, which is connecting the mentioned parts and wherein the phone window is foldable against the hard body part along a hinge line created in the soft middle part.

2. The base part according to claim 1, wherein to the base part are integrated one or more of the following parts: a display light guide, a keypad light guide, a keypad, a keypad graphics, a keypad contacting surfaces, a display holder, a display connector holder, an earpiece holder, a buzzer holder, a display gasket, an earpiece gasket, a buzzer gasket.

3. A mobile phone, wherein the mobile phone has one base part which is integrated of a hard body part, a phone window and a soft middle part, which is connecting the mentioned parts and that the phone window is foldable against the hard body part along a hinge line created in the soft middle part.

4. The mobile phone according to claim 3, wherein to the base part are integrated one or more of the following parts; a display light guide, a keypad light guide, a keypad, a keypad graphics, a keypad contacting surface, a display holder, a display connector holder, an earpiece holder, a buzzer holder, a display gasket, an earpiece gasket, a buzzer gasket.

5. The mobile phone according to claim 3, wherein to the mobile phone are also connected a upper cover and a back cover containing an engine of the phone including a battery.

6. A method of manufacturing a base part for a mobile phone by injection molding, wherein the method comprising:
a) performing a first stage of injection molding with a first injection mold producing a phone window and a hard body part of hard plastic
b) performing a second stage of injection molding with a soft elastomere producing a soft middle part which has a hinge line to fold up the phone window against the hard body part.

7. The method according to claim 6, wherein at the first injection molding stage a) are produced one or more of the following parts which are integrated to the base part: a display holder, a display connector holder, an earpiece holder, a buzzer holder, a keypad, a keypad graphics, a display light guide, a keypad light guide.

8. The method according to claim 6, wherein at the second injection molding stage b) are produced one or more of the following parts and integrated to the base part: a display gasket, an earpiece gasket, a buzzer gasket, a keypad contacting surface.

9. Mobile phone part, comprising:
means for providing a hard body base;
means for providing a phone window; and
means for providing a soft middle part for connecting the hard body base and the phone window so that the phone window is foldable against the hard body base along a hinge line in the soft middle part.

10. The mobile phone part of claim 9, wherein the means for providing said hard body base includes one or more of the following parts integrated thereto: means for providing a display light guide, means for providing a keypad light guide, means for providing a keypad, means for providing keypad graphics, means for providing a keypad contact surface, means for providing a display holder, means for providing a display connector holder, means for providing an earpiece holder, means for providing a buzzer holder, means for providing a display gasket, means for providing an earpiece gasket, means for providing a buzzer gasket.
